(19) United States
(12) Patent Application Publication
(10) Pub. No.: US 2014/0227907 A1
(43) Pub. Date: Aug. 14, 2014

(54) CONNECTOR

(71) Applicant: Yazaki Corporation, Tokyo (JP)

(72) Inventors: Haruki Yoshida, Makinohara-shi (JP); Yoshiaki Ozaki, Makinohara-shi (JP)

(73) Assignee: Yazaki Corporation, Tokyo (JP)

(21) Appl. No.: 14/348,176

(22) PCT Filed: Sep. 29, 2011
(86) PCT No.: PCT/JP2011/072455

§ 371 Date: Mar. 28, 2014

(51) Int. Cl. H01R 13/658

(52) U.S. Cl. CPC H01R 13/658
USPC 439/607.01; 439/625

(57) ABSTRACT

For providing a connector, which can secure reliability of connection between a terminal and an electric component connected to the terminal even if a car is vibrated in driving, a connector includes a terminal having an electric contact portion and connected to an electric wire, and a connector housing having a terminal receiving section holding the terminal. The electric contact portion is arranged to be inclined to a horizontal direction.

### TECHNICAL FIELD

This invention relates to a connector for supplying electric power from an electric power source to various electronic apparatus.

### BACKGROUND ART

Many various electronic apparatuses are provided in a car as a movable body. For distributing electric power from an electric power source to the various electronic apparatuses, an electric connection box, which is integrated with electric components such as a connector, a relay and a fuse, is arranged suitably in the car.

A junction block as the electric connection box is provided with electric components, such as a relay, fuse and a connector which are connected to the electronic apparatus. A plurality of mount faces, which a bolt to be joined with an end of a wiring harness connected to the electric components and the electric power source is provided, is arranged. The plurality of mount faces is arranged in parallel to horizontal direction so as to be shifted to each other along a direction perpendicular to the horizontal direction (that is arranged stepwise). At an end of wiring harness, the connector is provided, and the bolt, which is arranged at the mount face, is inserted through the electric contact portion of the connector, so that the bolt and the connector (that is wiring harness) are connected electrically (for example, Patent Document 1).

### CITATION LIST

### Patent Document

Patent Document 1: Japan Patent Application Published No. 2005-1.30635

### SUMMARY OF INVENTION

### Objects to be Solved

According to the connector by prior art, there are following problems: stress force by up-down (vertical) vibration of the car in driving is loaded without dispersion at the electric contact portion which is overlapped on the mount face and the bolt connected with the electric component is inserted through. Thereby, terminal may be broken and an electric wire connected with the terminal may be removed from the terminal, so that connection trouble may be occurred, for example, electric connection between the terminal and the electric components connected with the terminal would be shut.

For solving the above problems, reliability of connection between the terminal and the electric component connected with the terminal may be secured by increasing diameter of an electric wire. Thereby, a problem of cost increasing is resulted.

According to the above problems, an object of the present invention is to provide a connector, which can secure reliability of connection between a terminal and an electric component connected with the terminal in the car vibrated by driving without cost increasing.

### How to Attain the Object of the Present Invention

In order to overcome the above problems and attain the object, the present invention claimed in claim 1 is to provide a connector which includes a terminal connected with an electric wire and having an electric contact portion, and a connector housing including a terminal receiving section holding the terminal; and is characterized in that the electric contact portion is held to be inclined about horizontal direction.

The invention claimed in claim 2 is characterized in that the terminal receiving section is formed by a plurality of clamp members clamping the terminal therebetween, and includes a tubular open-preventing member.

The invention claimed in claim 3 is characterized in that the open-preventing member is formed to have an elliptical shape in plan view.

The invention claimed in claim 4 is characterized in that the open-preventing member performs as an electric conductive shield member.

### Effects of the Invention

According to the present invention claimed in claim 1, the connector includes the terminal connected with the electric wire and having the electric contact portion, and the connector housing having the terminal receiving section holding the terminal; and the electric contact portion is held to be inclined about horizontal direction. Thereby, stress force, which is caused by up-down (that is vertical) vibration of the car in driving and added on the electric contact portion (that is the terminal) held inclined to the horizontal direction, is dispersed and reduced. Therefore, a connector, in which it is not required to increase thickness of the terminal and diameter of the electric wire, and reliability of connection between the terminal and the electric component connected with the terminal can be secured in a long term without cost increasing, can be provided.

According to the present invention claimed in claim 2, the terminal receiving section is formed by the plurality of clamp members clamping the terminal therebetween, and includes the tubular open-preventing member, so that, by easy operations of positioning the terminal between the plurality of clamp members and moving the plurality of clamp members near to the terminal, the terminal receiving section can be assembled to the terminal. Thus, workability of assembling the connector can be improved. The tubular open-preventing member, which covers around an outer surface of the plurality of clamp members, is provided, so that when stress is loaded on the terminal, the terminal receiving section is prevented from separating to each other. Thus, reliability of connection between the terminal and the electric component can be more secured.

According to the present invention claimed in claim 3, the open-preventing member is formed to have an elliptical shape in plan view, so that height of the connector along a direction intersecting (perpendicular to) both of the horizontal direction and a lengthwise direction of the electric wire can be more reduced (that is miniaturized).

According to the present invention claimed in claim 4, the open-preventing member performs as an electric conductive shield member, so that electric noise into the electric wire (shield wire) can be reduced without increasing number of components.

### BRIEF DESCRIPTION OF DRAWINGS

FIG. 1 is a perspective view of a connector unit including a connector of the first embodiment according to the present invention;

FIG. 2 is a perspective view of the connector shown in FIG. 1;

FIG. 3 is a exploded perspective view of the connector shown in FIG. 2;

FIG. 4 is a front view of the connector shown in FIG. 2; and

FIG. 5 is an illustration showing the connector shown in FIG. 2 being connected to an electric connection box.

### DESCRIPTION OF EMBODIMENTS

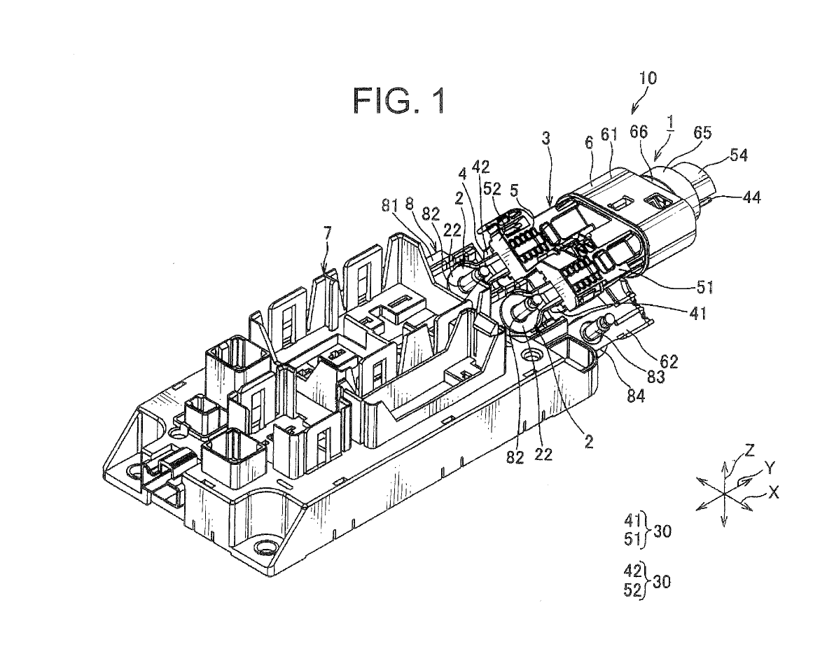

A connector of an embodiment according to the present invention is described with reference to drawings FIGS. 1-5.

A connector unit 10 shown in FIG. 1 includes a connector 1 having an electric contact portion 22, and a connector receiving member 8 having a mount face 81a, which the electric contact portion 22 is overlapped on. The connector receiving member 8 may be attached at an engine room of a car, and arranged at a junction block 7 as an electric connection box for supplying electric power to various electronic components mounted in the car.

The junction block 7 is formed into a box shape by insulation resin. The junction block 7 includes electric components such as a relay, a fuse and a connector. The electric components such a relay, a fuse, a connector are connected through the connector receiving member 8 arranged at the junction block 7 to the connector 1.

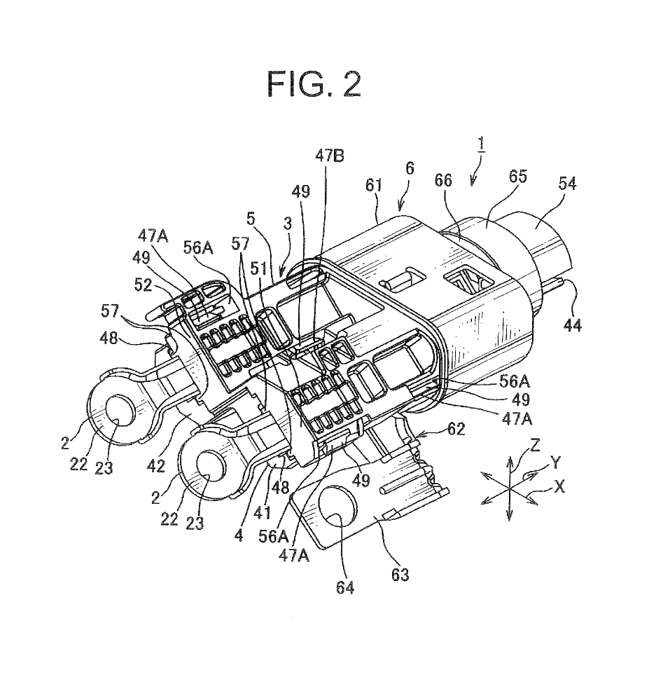

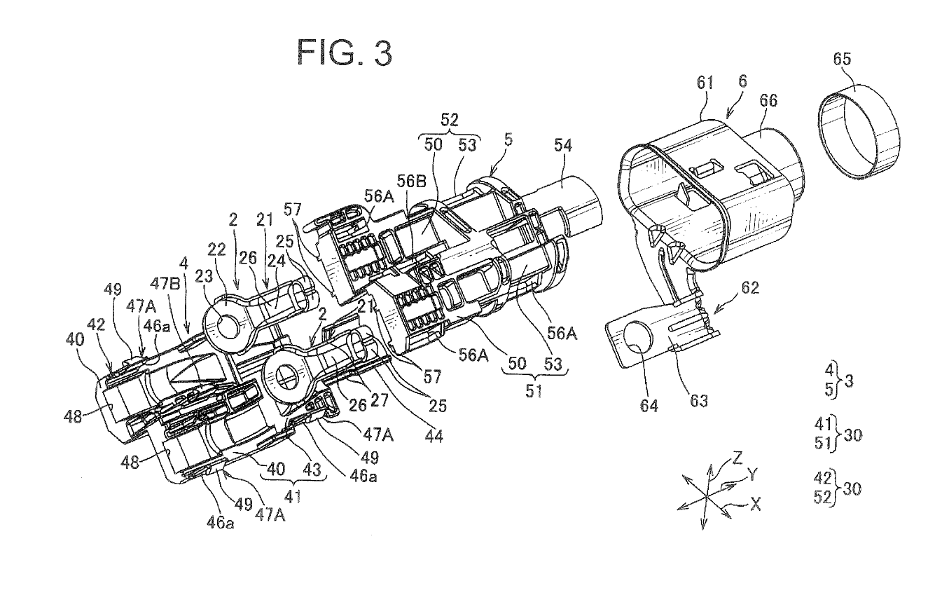

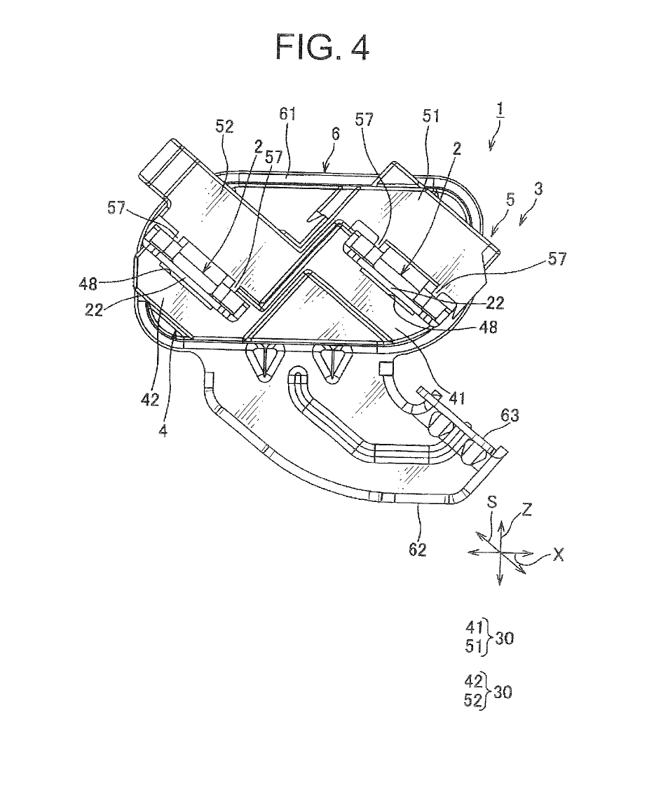

The connector 1 includes a plurality of terminals 2 connected respectively to each of a plurality of later-described covered wires of a shieldwire, a connector housing 3 holding the plurality of terminals 2 and a shield shell 6 attached at the connector housing 3 as shown in FIGS. 2 and 3. An arrow Y shown in FIGS. 2 and 3 indicates a lengthwise direction of the shield wire (covered wires). An arrow X indicates a direction, along which a plurality of terminal receiving sections 30 holding the plurality of terminals 2 is arranged in row. An arrow Z indicates a height direction perpendicular to both of the direction Y and the direction X (call height direction Z). The connector 1 is arranged so as to make the direction X in parallel to the horizontal direction as shown in FIG. 4 (call horizontal direction X after this). The height direction Z is aligned in parallel to a direction of up-down vibration (that is vertical direction) of the car in driving.

The shield wire is structured with a plurality of covered wires having respectively an electric conductive core wire and an insulation cover covering the core wire; a shield braid formed by braiding wire elements made of electric conductive metallic material, and covering the plurality of covered wires so as to limit electric noise leakage toward an outside of covered wires; and an insulation outer sheath covering the shield braid.

The plurality of terminals 2 is arranged in intervals to each other along the horizontal direction X, as shown in FIGS. 2 and 3. Each of terminals 2 is formed by punching and bending a conductive sheet metal. The terminal 2 includes integratedly the electric contact portion 22 connected with the connector receiving member 8 and a wire connecting portion 21 continued to the electric contact portion 22.

The electric contact portion 22 is formed into a plate shape as shown in FIGS. 3 and 4. The electric contact portion 22 is arranged along a direction inclined to the horizontal direction X (shown only in FIG. 4; call inclined direction S). The inclined direction S intersects both the horizontal direction X and the height direction Z. The plurality of terminals 2 is arranged in parallel to each other along the inclined direction S. The electric contact portion 22 is formed into a round shape in top view, and provided at a central area with a hole 23 which a bolt 82 of the later-described connector receiving member 8 is inserted through.

The wire connecting portion 21 includes integratedly a bottom plate 24 continued to the electric contact portion 22 and formed into a rectangular shape; a pair of cover clamp pieces 25 provided at an (top) end of the bottom plate 24 farther from the electric contact portion 22 along a lengthwise direction (shown by an arrow Y) of the bottom plate 24; and a core wire joining portion 26 provided between the electric contact portion 22 and the pair of cover clamp pieces 25, as shown in FIG. 3. The core wire joining portion 26 is a part of the bottom plate 24. The lengthwise direction (direction Y) of the wire connecting portion 21 (that is terminal 2) and a lengthwise direction (direction Y) of the electric wire connected with the wire connecting portion 21 are arranged in parallel to each other.

The pair of cover clamp pieces 25 is extending vertically from both edges of the bottom plate along a widthwise direction (direction X). The pair of cover clamp pieces 25 is bent so as to make an end thereof farther from the bottom plate 24 nearer to the bottom plate 24. The pair of cover clamp pieces 25 clamps the cover between the bottom plate 24 and itself, and presses the cover so as to join mechanically the cover clamp pieces 25 and the electric wire.

The core wire joining portion 26 is provided with a pair of vertical pieces 27 extending vertically from both side ends of the bottom plate 24 in a widthwise direction of the bottom plate 24 (direction X). Between the pair of vertical pieces 27, the core wire, which is exposed by peeling the cover of the electric wire, is placed. After the core wire is overlapped on the core wire joining portion 26, the core wire joining portion 26 and the core wire are joined by ultrasonic joining, thereby, the core wire joining portion 26 (the wire connecting portion 21) and the core wire of the electric wire are joined electrically. Instead, by clamping the core sire between the vertical pieces and the bottom plate 24, and pressing the vertical pieces 27, the core wire joining portion 26 (wire connecting portion 21) and the core wire may be joined electrically.

The connector housing 3 is formed by insulation resin. The connector housing 3 is structured by a lower housing 4 provided with a plurality of lower clamp portions 41, 42, and an upper housing 5 provided with a plurality of upper clamp portions 51, 52 and assembled with the lower housing 4, as shown in FIG. 2.

The connector housing 3 is provided with a plurality of terminal receiving sections 30 holding the terminal 2. The terminal receiving section 30 is structured by each of the lower clamp portions 41, 42 of the lower housing 4, and each of upper clamp portions 51, 52 of the upper housing 5, which are assembled to the lower clamp portions 41, 42. The lower clamp portions 41, 42 and the upper clamp portions 51, 52 correspond to a plurality of clamp members in claims.

The lower housing 4 includes the plurality of lower clamp portions 41, 42 formed into a cubical shape, a projecting portion 44, and a plurality of lock arms 47A, 47B. The lower clamp portions 41, 42 are arranged at one end of the lower housing 4 in the direction Y, as shown in FIG. 3. The projecting portion 44 is arranged at the other end of the lower housing 4 so as to continue to the lower clamp portions 41, 42.

The plurality of lower clamp portions 41, 42 is connected to each other along the horizontal direction X in parallel to each other along the inclined direction S, as shown in FIG. 4. Each of edges of the plurality of lower clamp portions 41, 42 along the inclined direction S is arranged along the horizontal direction X.

Each of the lower clamp portions 41, 42 includes a main body 40 having a groove portion 48 receiving the electric wire and the terminal 2 connected with the electric wire, and a shell mount portion 43 continued to the main body 40. The groove portion 48 is formed to be recessed from an inner surface of the main body 40.

At the shell mount portion 43, a later-described shell mount portion 53 of the upper housing 5. When the later-described shell mount portion 53 is assembled to the shell mount portion 43, the terminal 2 with the electric wire is placed between the shell mount portions 43, 53. The shield shell 6 is mounted (covers) around outsides of each of shell mount portions 43 provided respectively at the lower clamp portions 41, 42 and each of shell mount portions 53 provided respectively at the upper clamp portions 51, 52.

The projecting portion 44 is formed into a plate shape. The projecting portion 44 is arranged so as to project toward the direction Y and placed at a position to oppose along the direction Z against a later-described projecting portion 54 provided at the upper housing 5. The terminal 2 with the electric wire is placed between the projecting portions 44 and 54.

Three as the plurality of lock arms 47A are provided in the embodiment. The three lock arms 47A are arranged at the end of the lower housing 4 in the direction S. Two of three lock arms 47A are arranged at each of main bodies 40 provide at the lower clamp portions 41, 42. Remained one of the three lock arms 47A is arranged at the shell mount portion 43 of the lower clamp portion 41. Each of lock arms 47A includes a vertical piece 46a extending vertically toward the upper clamp portions 51, 52 (upper housing 5) and a lock portion 49 arranged at the vertical piece 46a.

The lock arm 47B includes a vertical piece 46b extending vertically toward the upper clamp portions 51, 52 (upper housing 5) and a lock portion 49 arranged at the vertical piece 46b. The lock arm 47B is arranged between the lock arms 47A provided respectively at each of main body 40. A length of the vertical piece 46b of the lock arm 47B along a direction toward the upper clamp portions 51, 52 (upper housing) is formed longer than that of the vertical piece 46a of the lock arm 47A.

The upper housing 5 includes the plurality of upper clamp portions 51, 52 formed into a cubical shape, projecting portion 54 and a plurality of lock receiving portions 56A and 56B. The upper clamp portions 51, 52 are arranged at one end of the upper housing 5 in the direction Y. The projecting portion 53 is arranged at the other end of the upper housing 5 so as to be continued to the upper clamp portion 51, 52.

The plurality of upper clamp portions 51, 52 is connected along the horizontal direction X and arranged along the inclined direction S in parallel to each other, as shown in FIG. 4. Thus, the plurality of upper clamp portions 51, 52 is arranged along the inclined direction S in parallel to each other, as shown in FIG. 4, so that each edge of the plurality of upper clamp portions 51, 52 along the inclined direction S is arranged along the horizontal direction X. When each of the lower clamp portions 41, 42 and each of the upper clamp portions 51, 52 are assembled to each other, total dimension of adjacent clamp portions 41, 51 and total dimension of adjacent clamp portions 42, 52 along height direction Z are in the same value.

Each of the upper clamp portions 51, 52 includes a main body 50 having a pair of projections 57, which penetrates into the groove portion 48 of the main body 40, and a shell mount portion 53 continued to the main body 50. The pair of projections 57 is arranged in an interval to each other along the inclined direction S so as to position the wire connecting portion 21 of the terminal 2 therebetween. The projection 57 is formed projectingly from an inner surface of the upper clamp portion 51, 52 which is overlapped on the inner surface of the lower clamp portion 41, 42. The projection 57 also extends along the direction Y.

The projection 57 is formed into a plate shape. The projection 57 is arranged to project in the direction Y.

The lock receiving portion 56A is configured to be locked with the lock arm 47A. The lock receiving portion 56B is configured to be locked with the lock arm 47B. The lock receiving portions 56A and 56B are formed into a frame shape to insert each of lock arms 47A and 47B therethrough.

The shield shell 6 includes a shell main body 61 as a shield member covering each of shell mount portions 43, 53 of the clamp portions 41, 42, 51, 52; a braid mount portion 66 continued to the shell main body 61 so as to be covered by an end of the shield braid of the shield wire; an earth portion 62 continued to the shell main body 61 so as to connect the shield shell main body 61 to the junction block 7; and a shield ring 65 formed into a tubular shape so as to hold the shield braid to the braid mount portion 66, as shown in FIGS. 3 and 4. The shell main body 61, the braid mount portion 66 and the earth portion 62 are formed integratedly.

The shell main body 61 is made of electric conductive metal. The shell main body 61 is formed into a tubular shape with an oval shape in plan view as shown in FIG. 4. The oval shape shell main body 61 is arranged at outer surfaces of the shell mount portions 43, 53 of each of clamp portions 41, 42, 51, 52 so as to align a major axis of the oval shape in parallel to the horizontal direction X and a minor axis of the oval shape in parallel to the height direction Z. In the embodiment, the oval shape means not only to ellipse shape having a curvature, any point on which is defined to have constant value of sum of one length between the point and one of two fixed points on a plan and another length between the point and another of the two fixed points, but also oval shape for example the main body 61 shown in FIG. 4 having straight portion. The shell portion corresponds to an open-preventing member in claim.

The braid mount portion 66 is formed into a tubular shape having length in the direction X shorter than that of the shell main body 61. The projecting portions 44, 54 are inserted through the braid mount portion 66.

The earth portion 62 is provided with a plate-shaped mount portion 63 in parallel to the electric contact portion 22 (inclined direction S). The mount portion 63 includes a hole 64 formed into round shape in top view at a central area thereof so as to insert a later-described bolt 83 arranged at the junction block 7 therethrough.

The connector receiving member 8 is arranged at an end of the junction block 7 in the direction Y, as shown in FIG. 1. The connector receiving member 8 includes a main body 81 having a plurality of mount faces 81a and a plurality of bolts 82 extending from the mount faces 81a. The main body 81 is made of insulation resin and form into a cubical shape. The mount face 81a is formed into a flat surface. The plurality of mount faces 81a is arranged in parallel to the plurality of electric contact portions 22 (along the inclined direction S), and also in parallel to each other. The edges of the plurality of mount faces 81a in the inclined direction S are arranged along the horizontal direction X. The plurality of bolts 82 is connected with the electric components mounted at the junction block 7.

The junction block 7 is provided with a mount face 84 arranged in parallel to the plurality of mount faces 81a (in the inclined direction S). The mount face 84 is formed into a flat surface and the mount portion 63 of the shield shell 6 is overlapped thereon. The mount face 84 is provided with a bolt 83 extending from the mount face 84 so as to be connected electrically with the earth portion at a car panel of the car.

The connector unit 10 having the above-mentioned connector 1 is assembled as following: First, the end of each electric wire is joined to the wire connecting portion 21 of the terminal 2, and then, the electric wire and the wire connecting portion 21 connected with the electric wire are placed at the groove portion 48 of the lower clamp portion 41, 42 of the lower housing 4. At this time, the electric contact portion 22 of the terminal 2 is arranged so as to project from the lower housing 4 in the direction Y.

Second, the upper housing 5 is placed against the lower housing 4 so as to oppose respectively the clamp portion 41 to the clamp portion 51, the clamp portion 42 to the clamp portion 52 and projecting portion 44 to the projecting portion 54, and the lock arm 47B of the lower housing 4 is approached to the lock receiving portion 56B of the upper housing 5. Thus, the lower housing 4 and the upper housing 5 are positioned. The housings 4 and 5 are more approached, so that the terminal 2 is placed between the pair of projections 57 of the upper housing 5, and the lock arm 47A is locked with the lock receiving portion 56A. Accordingly, the lock arms 47A and 47B are locked respectively with the lock receiving portions 56A and 56B, so that the clamp portions 41 and 51, the clamp portion 42 and 52 are assembled to each other and the plurality of terminal receiving sections 30 is assembled. At the time, the plurality of electric contact portions 22 is held respectively in the terminal receiving sections 30 in parallel to each other along the inclined direction S. The plurality of terminal receiving sections 30 structured by the polarity of clamp portions 41, 51, 42, 52 is connected along the horizontal direction X in parallel to the plurality of electric contact portion 22 (along the inclined direction S).

Furthermore, the braid mount portion 66 is covered by the end of shield braid, and the shield ring 65 is placed so as to surround outside of the shield braid covering the braid mount portion 66. By pressing the shield ring 65, the shield braid is fixed on the braid mount portion 66 (shield shell 6). By arranging the shield shell 6, on which the shield braid is fixed, around outside of the shell mount portions 43, 53 (connector housing 3), the shield shell 6 is mounted to the connector housing 3. Thus, the connector 1 is assembled.

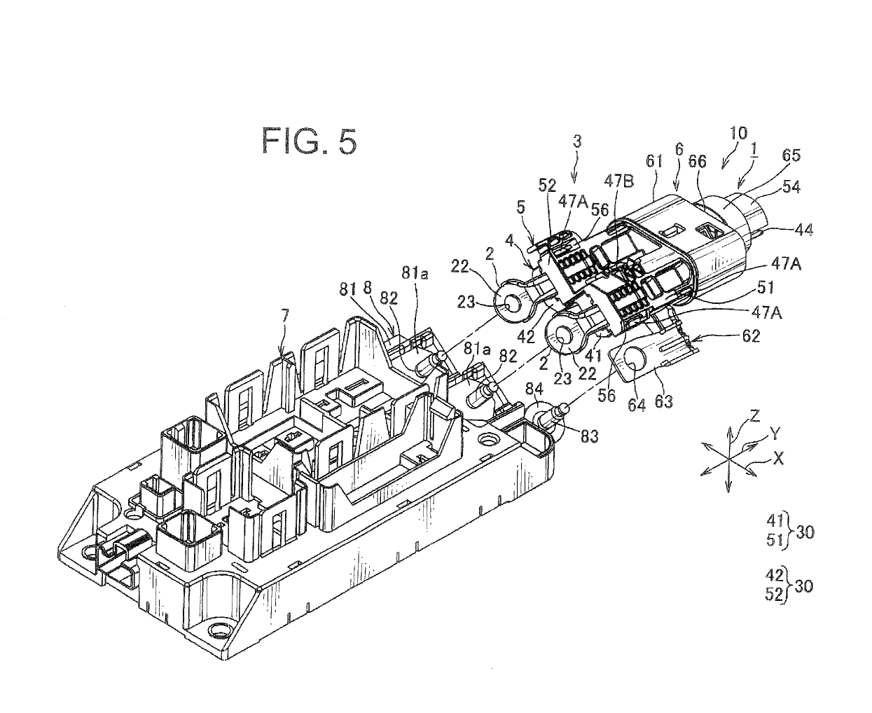

As shown in FIG. 5, the electric contact portion 22, the hole 23 of which the bolt 82 is inserted through, is overlapped on the mount face 81a, and the mount portion 63, the hole 64 of which the bolt 83 is inserted through, is overlapped on the mount face 84. Thereafter, a nut is screwed respectively to the bolts 82, 83, and the connector 1 is mounted at the connector receiving member 8 (junction block 7). Thereby, the shield shell 6 of the connector 1 is electrically connected to electric components arranged at the junction block 7, so that the shield shell 6 of the connector 1 discharges the electric noise through the shell main body 61 and the earth portion 62 to the car panel (car body) by earthing. Thus, the connector unit 10 is assembled.

According to the above embodiment, in the connector 1, which includes the terminal 2 connected with the electric wire and having the electric contact portion 22, and the connector housing 3 having the terminal receiving section 30 holding the terminal 2, the electric contact potion 22 is held so as to be inclined to the horizontal direction X. Thereby, stress force, which is caused by up-down (that is vertical) vibration of the car in driving and added on the electric contact portion (that is the terminal 2) held inclined to the horizontal direction X, is dispersed and reduced. Therefore, the connector 1, in which it is not required to increase thickness of the terminal 2 and diameter of the electric wire, and reliability of connection between the terminal 2 and the electric component connected with the terminal 2 can be secured in a long term without cost increasing, can be provided.

The terminal receiving sections 30 are arranged along the horizontal direction X in parallel to the electric contact portion 22, that is the terminal receiving sections are inclined to the horizontal direction X, so that the dimension of the connector 1 along the height direction Z intersecting (perpendicular) to both of the horizontal direction X and the lengthwise direction of the electric wire is limited constantly. Thereby, the height of the connector 1 can be low-profiled. Also, the terminal receiving sections 30 are inclined to the horizontal direction X, so that the connector 1 can be miniaturized about the horizontal direction X.

The terminal receiving sections 30 are structured therebetween by the clamp portions 41, 42, 51, 52 holding the terminal 2, and include the tubular shell main body 61 as the open-preventing member covering around the outside of the clamp portions 41, 42, 51, 52. By the easy operation of placing the terminal 2 between the clamp portions 41, 42, 51, 52 and making the terminal 2 approaching to the clamp portions 41, 42, 51, 52, the terminal 2 is assembled to the terminal receiving section 30. Thereby, workability of assembling the connector 1 can be improved. The connector 1 includes the tubular shell main body 61 covering around the outside of the clamp portions 41, 42, 51, 52, so that when the terminal 2 is stressed, the terminal receiving sections 30 are prevented to be separated. Therefore, reliability of connection between the terminal 2 and the electric component connected with the terminals 2 can be more secured.

The shell main body 61 as the open-preventing member is formed into an elliptical shape in plan view, so that height of the connector 1 along the height direction Z intersecting (perpendicular to) both of the horizontal direction X and the lengthwise direction (direction Y) of the electric wire can be more reduced (that is miniaturized).

The shell main body 61 as the open-preventing member is formed as an electric conductive shield member, so that electric noise of the shield wire can be reduced without increasing number of components.

The connector unit 10 includes the above-mentioned connector 1 and the mount face 81a overlapped on the electric contact portion 22 and inclined to the horizontal direction X, so that stress force, which is caused by up-down (that is vertical) vibration of the car in driving and added on the electric contact portion (that is the terminal 2) held inclined to the horizontal direction X, is dispersed and reduced. Therefore, the connector unit 10, in which it is not required to increase thickness of the terminal 2 and diameter of the electric wire, and reliability of connection between the terminal 2 and the electric component connected with the terminal 2 can be secured in a long term without cost increasing, can be provided.

In the junction block 7 as the electric connection box, which includes the mount face 81a overlapped on the electric contact portion 22 provided at the connector 1, the mount face 81a is inclined to the horizontal direction X, so that stress force, which is caused by up-down (that is vertical) vibration of the car in driving and added on the electric contact portion (that is the terminal 2) held inclined to the horizontal direction X, is dispersed and reduced. Therefore, the junction block 7 as the electric connection box, in which it is not required to increase thickness of the terminal 2 and diameter of the electric wire, and reliability of connection between the terminal 2 and the electric component connected with the terminal 2 can be secured in a long term without cost increasing, can be provided.

According to the above-mentioned embodiment, the junction box 7, which includes the mount face 81a inclined to the horizontal direction X, is provided. The present invention is not limited in such embodiment, for example, a fuse block or a relay box which includes the mount face 81a inclined to the horizontal direction X, can be provided.

According to the above-mentioned embodiment, the connector 1 includes the plurality of terminals 2. The present invention is not limited in such embodiment, for example, at least one terminal 2 may be provided. According to the above-mentioned embodiment, the connector 1 includes the plurality of terminal receiving sections 30. The present invention is not limited in such embodiment, for example, at least one terminal receiving sections 30 may be provided.

According to the above-mentioned embodiment, each of the terminal receiving sections 30 includes two members which are the lower clamp portions 41, 42 and the upper clamp portions 51, 52 as the separable clamp portions. The present invention is not limited in such embodiment, for example, each of the terminal receiving sections 30 can include three or more separable clamp portions.

According to the above-mentioned embodiment, the shell main body 61 as the shield member is provided as the open-preventing member. The present invention is not limited in such embodiment, for example, any member made of insulation resin can be provided as the open-preventing member.

The present inventions are described based in the embodiments as mentioned above, but the present invention is not limited in above embodiments. Various change and modifications can be made with the scope of the present invention.

### MARK LIST

1 Connector
2 Terminal
22 Electric contact portion
3 Connector housing
30 Terminal receiving section
41, 42 Lower clamp portion (clamp portion)
51, 52 Upper clamp portion (clamp portion)
61 Shell main body (prevent portion)

1. A connector, comprising:
a terminal connected with an electric wire and having an electric contact portion; and
a connector housing including a terminal receiving section holding the terminal,
wherein the electric contact portion is held to be inclined about horizontal direction.

2. The connector claimed in claim 1, wherein the terminal receiving section is formed by a plurality of clamp members clamping the terminal therebetween, and includes a tubular open-preventing member covering around an outside of the plurality of clamp members.

3. The connector claimed in claim 2, wherein the open-preventing member is formed into an elliptical shape in plan view.

4. The connector claimed in claim 2, wherein the open-preventing member performs as an electric conductive shield member.

5. The connector claimed in claim 3, wherein the open-preventing member performs as an electric conductive shield member.
